(19) United States
(12) Patent Application Publication
(10) Pub. No.: US 2007/0175693 A1
(43) Pub. Date: Aug. 2, 2007

(54) Floor conveyor

(76) Inventor: Norbert Krimbacher, Satteins (AT)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/490,872

(22) Filed: Jul. 20, 2006

(30) Foreign Application Priority Data
Jul. 21, 2005 (DE) 20 2005 011 503.7

(51) Int. Cl. B60K 17/14

(52) U.S. Cl. 180/308

(57) ABSTRACT

The present disclosure relates to a steerable floor conveyor with at least partly driven wheels, wherein the driven wheels can be driven by means of individual drives and a lateral wheel force controller is provided, which controls the driving torque of the driven wheels.

### CROSS-REFERENCE TO RELATED APPLICATION

This application claims priority to German Utility Model Application Serial No. 20 2005 011 503.7 filed Jul. 21, 2005, which is hereby incorporated by reference in its entirety for all purposes.

### FIELD

The present disclosure relates to a steerable floor conveyor with at least partly driven wheels.

### BACKGROUND AND SUMMARY

In floor conveyors, the two unsteered front wheels usually are driven, whereas the non-driven rear wheels are steered. This technical realization leads to a favorable and robust construction. As drive, such floor conveyors employ for instance hydrostatic drives with succeeding differential gear, or also electric drives.

FIG. 1 shows a simplified sketch of the drive conditions of a floor conveyor of the construction described above. For reasons of simplicity, the floor conveyor 10 here is provided with two non-steered driven front wheels 12 and 14 and one steered non-driven rear wheel 16. The driven wheel 12 transmits the driving torque M_{L}. The driven front wheel 14 produces the driving torque M_{R}, whereby the vehicle is moved in the direction of travel with the speed v. The steering angle Φ is established by the steered wheel 16. As in floor conveyors great steering angles Φ are realized or small turning radii are desired, high lateral forces F_{Q} (cf. FIG. 1) are applied onto the steering rear wheel 16 or the steering rear wheels during cornering. The use of a differential gear does not provide for actively influencing the existing lateral wheel forces of the steered wheel. This lateral force F_{Q} has a disturbing influence in the case of fine positioning operations, as in these operating ranges the vehicle can only be steered inaccurately due to the existing lateral wheel force and the finite rigidity of the tires transverse to the wheel axis. In the case of smaller-size wheels, one tries to counteract these physical conditions by a compact and robust design of the tires. In the case of a larger size, these problems can, however, no longer be overcome by the design of the tires, as in this case comparatively higher mechanical loads will occur.

Therefore, it is the object of the present disclosure to create a steerable floor conveyor with at least partly driven wheels, which can be steered into a desired target position easily and precisely.

In accordance with the present disclosure, this object is solved by the embodiments described herein. Accordingly, there is created a steerable floor conveyor with at least partly driven wheels, wherein the driven wheels can be driven by means of individual drives, a lateral wheel force controller being provided, which controls the driving torque of the respectively driven wheels. Due to the separate drive of the driven wheels, the same can be changed and be actively influenced as desired, depending on the driving situation. As a result, an active steering assistance by the driven wheels and a stabilization of the vehicle can be achieved. Due to the active steering assistance, the occurring lateral wheel force, which as such also has a large influence on the useful life of the tires, is also reduced, whereby the service life of the tires is increased substantially.

Stabilization of the floor conveyor is understood to be the increase of the rigidity of the rear axle with respect to the steering system by an appropriate control. By minimizing the lateral forces acting on the steered wheels, the elastic deformations of the tires are minimized. As a result, the requirements of the vehicle operator can be translated more directly and more precisely onto the roadway. By a corresponding control of the individual drives, the transverse rigidity of the wheel is improved.

Accordingly, the front wheels can be driven by means of individual drives, whereas the non-driven rear wheels are steerable.

Alternatively, however, all wheels can be driven by means of individual drives.

In accordance with a preferred aspect of the present disclosure, the individual drives can be electric motors.

In accordance with another aspect of the present disclosure, it is proposed to configure the individual drives as hydraulic motors.

These hydraulic drives can be realized in a closed hydraulic circuit. The individual drives can include separate hydraulic circuits. On the other hand, the individual drives of two driven wheels can also include two interconnected hydraulic motors with a common pump.

Advantageously, the lateral wheel force controller is part of a lateral wheel force control circuit for minimizing the transverse wheel load.

In the control circuit, the current lateral wheel force can be considered, the same being determined by means of model calculations based on measured values. As measured values, the steering angle can be used for instance. The lateral wheel force can, however, also be measured directly within the steering axle.

### BRIEF DESCRIPTION OF THE FIGURES

Further features, details and advantages of the invention can be taken from the embodiments illustrated in the drawing, in which:

FIG. 1 shows a schematic representation of a floor conveyor to explain the physical quantities occurring here;

FIG. 2 shows a schematic representation of a hydraulic drive concept of an inventive floor conveyor in accordance with a first embodiment; and

FIG. 3 shows a schematic hydraulic concept for a drive of a floor conveyor in accordance with a second embodiment of the present disclosure.

### DETAILED DESCRIPTION

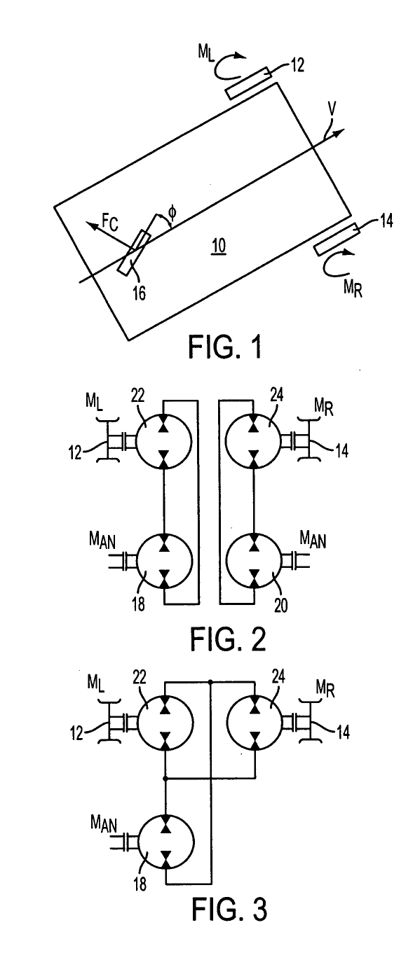

In accordance with the first embodiment of a hydraulic concept as shown in FIG. 2, an individual wheel drive for the driven wheels 12 and 14 (cf. FIG. 1) can be realized by two completely closed hydraulic circuits as they are illustrated here. In this concept, comparatively smaller pumps 18 and 20 can be used for driving the hydraulic motors 22 and 24. The hydraulic motors 22 and 24 are operated in the two-quadrant mode. The full four-quadrant mode necessary is accomplished by the pumps.

In the second system as shown in FIG. 3, the two hydraulic motors 22 and 24 are coupled hydraulically. In this system, only one—but larger—pump 18 is required. To achieve the complete finctionality, the motors must be operated here in the four-quadrant mode.

1. A steerable floor conveyor comprising at least partly driven wheels, wherein the driven wheels can be driven by means of individual drives and a lateral wheel force controller is provided, which controls the driving torque of the driven wheels.

2. The floor conveyor as claimed in claim 1, wherein the front wheels are driven by means of individual drives and the non-driven rear wheels are steerable.

3. The floor conveyor as claimed in claim 1, wherein all wheels are driven by means of individual drives.

4. The floor conveyor as claimed in claim 1, wherein the individual drives are electric motors.

5. The floor conveyor as claimed in claim 1, wherein the individual drives are hydraulic motors.

6. The floor conveyor as claimed in claim 5, wherein the hydraulic drives are realized in a closed hydraulic circuit.

7. The floor conveyor as claimed in claim 5, wherein the individual drives include separate hydraulic circuits.

8. The floor conveyor as claimed in claim 5, wherein the individual drives of two driven wheels include two interconnected hydraulic motors with a common pump.

9. The floor conveyor as claimed in claim 1, wherein the lateral wheel force controller is part of a lateral wheel force control circuit for minimizing the transverse wheel load.

10. The floor conveyor as claimed in claim 9, wherein in the control circuit the current lateral wheel force can be considered, the same being determined by means of model calculations based on measured values.

11. The floor conveyor as claimed in claim 10, wherein the steering angle is determined as measured value.

12. A floor conveyor, comprising:
a first drive wheel;
a second drive wheel;
a first steered wheel;
a first hydraulic motor configured to drive the first drive wheel;
a second hydraulic motor configured to drive the second drive wheel; and
a lateral force controller configured to modify torques applied to the first drive wheel and the second drive wheel to reduce a transverse wheel load.

13. The floor conveyor of claim 12, further comprising a first hydraulic pump in fluid communication with the first hydraulic motor, and a second hydraulic pump in fluid communication with the second hydraulic motor.

14. The floor conveyor of claim 12, further comprising a single hydraulic pump in fluid communication with the first hydraulic motor and the second hydraulic motor.

15. The floor conveyor of claim 12, wherein the first drive wheel and the second drive wheel are each front wheels, and wherein the steered wheel is a rear wheel.

16. The floor conveyor of claim 12, wherein the lateral force controller is configured to determine a current lateral wheel force via model calculations based on measured values.

17. The floor conveyor of claim 16, wherein the measured values comprise a steering angle.

18. The floor conveyor of claim 12, wherein the lateral force controller is configured to receive a measurement of the current lateral wheel force from the steering axle.
